(19) United States
(12) Patent Application Publication
(10) Pub. No.: US 2016/0227509 A1
(43) Pub. Date: Aug. 4, 2016

(54) WIDEBAND RECEIVER FOR POSITION TRACKING SYSTEM IN COMBINED VIRUTAL AND PHYSICAL ENVIRONMENT

(71) Applicant: The Void, LLC, Pleasant Grove, UT (US)

(72) Inventor: Justin Krenz, Pleasant Grove, UT (US)

(73) Assignee: The Void, LLC, Pleasant Grove, UT (US)

(21) Appl. No.: 15/068,568

(22) Filed: Mar. 12, 2016

Related U.S. Application Data
(63) Continuation-in-part of application No. 14/942,878, filed on Nov. 16, 2015.
(60) Provisional application No. 62/080,308, filed on Nov. 15, 2014.
(60) Provisional application No. 62/080,307, filed on Nov. 15, 2014.

(51) Int. Cl. H04W 64/00; G01S 5/00; H04W 4/02

(52) U.S. Cl. CPC H04W 64/006; H04W 4/02; G01S 5/00

(57) ABSTRACT

A positional tracking system used in a virtual reality environment in which multiple users may freely and unrestrictedly explore an environment without affecting position tracking. Receivers mounted to the user in several locations may be accurately tracked regardless of the position of the user and other users in the system. A plurality of monitors may transmit wide band signals to one or more receivers on a user. Each receiver may receive the wide band signals from the plurality of transmitters, process those signals, and determine a receiver location based on the received signals. The signals themselves may be wide band signals, for example in the range of 3 GHz to 10 GHz. The wide band signals may include identifier information and a pulse for determining a time-of-flight between the transmitter and receiver.

### CROSS-REFERENCE TO RELATED APPLICATIONS

This application is a continuation in part and claims the priority benefit of U.S. patent application Ser. No. 14/942,878, titled “Combined Virtual and Physical Environment,” filed Nov. 15, 2015, which claims the priority benefit of U.S. provisional application 62/080,308, titled “Systems and Methods for Creating Combined Virtual and Physical Environments,” filed Nov. 15, 2014, and U.S. provisional application 62/080,307, titled “Systems and Methods for Creating Combined Virtual and Physical Environments,” filed Nov. 15, 2014, the disclosures of which are incorporated herein by reference.

This application is related to U.S. patent application Ser. No. 15/068,567, titled “Wideband Transmitter for Position Tracking System in Combined Virtual and Physical Environment,” filed Mar. 12, 2016, the disclosure of which is incorporated herein by reference

### BACKGROUND OF THE INVENTION

Virtual reality technology is becoming more sophisticated and available to the general public. Currently, many virtual reality systems require a user to sit in a chair, wear a bulky headset, and face a specific direction while limited optical sensors track certain movements of portions of the headset. As a user moves his head from side to side, an image provided to a user may change. The optical sensors provide a line-of-sight signal to a headset and may provide input to a remote server to update a graphical interface when the headset is detected to shift to the left or the right.

Virtual reality systems based on optical tracking have significant limitations. First, virtual-reality tracking systems based on optical sensors require a line of sight between the optical sensor and the user. If at any time something gets between the user and the optical sensor, such as a wall or another user, or even a part of the user's body if the user turns his or her back on the sensor, the optical sensor will fail to be detected and errors will occur in the virtual reality display. This is not a problem, typically, for virtual-reality systems in which a user sits in a chair and looks directly at optical sensors without any intervening objects. However, virtual-reality systems using optical sensors do not work for users where intervening objects may interrupt a line of sight between the sensor and the user, such as a virtual reality system where many users (i.e., players) may be present. What is needed is an improved position tracking system for a virtual-reality system.

### SUMMARY OF THE CLAIMED INVENTION

The present technology, roughly described, provides a positional tracking system for use in a virtual reality environment in which multiple users may freely and unrestrictedly explore an environment without affecting position tracking for each user. Receivers mounted to the user in several locations may be accurately tracked regardless of the position of the user and other users in the system. A plurality of monitors may transmit wide band signals to one or more receivers on a user. Each receiver may receive the wide band signals from the plurality of transmitters, process those signals, and determine a receiver location based on the received signals. The signals themselves may be wide band signals, for example in the range of 3 GHz to 10 GHz. The wide band signals, in some implementations, may include identifier information and a pulse for determining a time-of-flight between the transmitter and receiver.

The transmitter signals can be sent from a synchronized clock that outputs a wideband signal to the one or more receivers. Receivers may determine the time-of-flight information for each identified transmitter, determining the position of each receiver, and provide that information to a computing device. The computing device may determine the receiver location and provide that location information to a virtual reality engine. The virtual reality engine may update the user's perspective and other display and audio components within the virtual reality environment based on updated positional data.

In an embodiment, a method may be implemented for determining a time of flight for a signal within the position tracking system. The method may begin with receiving by a first receiver of a plurality of receivers, synchronized wide-band signals from a plurality of transmitters. The plurality of transmitters and plurality of receivers may be located within a physical environment in which the virtual reality experience is provided (e.g., a pod). The received synchronized wide-band signals received by the first receiver may be sub-sampled. A first correlation may be performed on the sub-sampled received synchronized signals. The time of flight of each wide band signal received by the first receiver based on the correlation may be determined. The time of flight and a corresponding transmitter identifier may be provided to a computer for each wide band signal.

In an embodiment, a method may be implemented for performing wideband position tracking. The method may begin with transmitting wide band identifier information and pulses from a plurality of transmitters. The wideband identifiers and pulses may be received and processed by a first receiver of a plurality of receivers. Time of flight data may be determined by receiver circuitry for each pulse received by the first receiver. The location of the receiver may be determined based on the time of flight of a plurality of pulses, such as for example at least three pulses, received by the receiver. A locally executing graphics engine, for example executing on a computing device coupled to or in close proximity to a particular user associated with the receivers, may be provided with the transmitter location. A graphical user display may be updated with updated information based on the graphics engine.

An embodiment may include a system for determining a time of flight for a signal within a position tracking system. The system may include an antenna and circuitry. The antenna can receive a plurality of synchronized wide band signals from a plurality of transmitters within a pod. The circuitry subsamples the received synchronized wide-band signals received by a first receiver of the plurality of receivers. The circuitry calculates a first correlation on the sub-sampled received synchronized signals. The circuitry determines the time of flight of each wide band signal received by the first receiver based on the correlation. The circuitry also provides to a computer the time of flight and a corresponding transmitter identifier for each wide band signal.

### BRIEF DESCRIPTION OF THE DRAWINGS

FIG. 1 is a block diagram of a virtual reality system with a wideband-based position tracking system.

FIG. 2 is an illustration of multiple receivers configured on a user's body.

FIG. 3 is a block diagram of a receiver.

FIG. 4 is a method for performing position tracking within a virtual reality system.

FIG. 5 is a method for receiving and processing and identifier and pulse by a receiver.

FIG. 6 is a block diagram of a computing device for use with the present technology.

### DETAILED DESCRIPTION

The present technology, roughly described, provides a positional tracking system for use in a virtual reality environment in which multiple users may freely and unrestrictedly explore a physical environment in which the virtual reality experience is provided (i.e., a pod) without affecting position tracking of each user. Receivers mounted to the user in several locations may be accurately tracked regardless of the position of the user and other users in the system. A plurality of monitors may transmit wide band signals to one or more receivers on a user. Each receiver may receive the wide band signals from the plurality of transmitters, process those signals, and determine a receiver location based on the received signals. The signals themselves may be wide band signals, for example in the range of 3 GHz to 10 GHz. The wide band signals may include identifier information and a pulse for determining a time-of-flight between the transmitter and receiver.

The transmitter signals can be sent from a synchronized clock that operates in wideband to the one or more receivers. Receivers may determine the time-of-flight information for each identified transmitter, determining the position of each receiver, and provide that information to a computing device. The computing device may determine the receiver location and provide that location information to a virtual reality engine. The virtual reality engine may update the user's perspective and other display and audio components within the virtual reality environment based on updated positional data.

The wide band signal receiving and processing system may be implemented as a series of components and circuitry, as an integrated circuit (IC) that processes signals, or in some other form. When implemented as an IC, the receiving system may implement the functionality and features discussed herein while including modifications known in the art for implementing such features in small-scale devices.

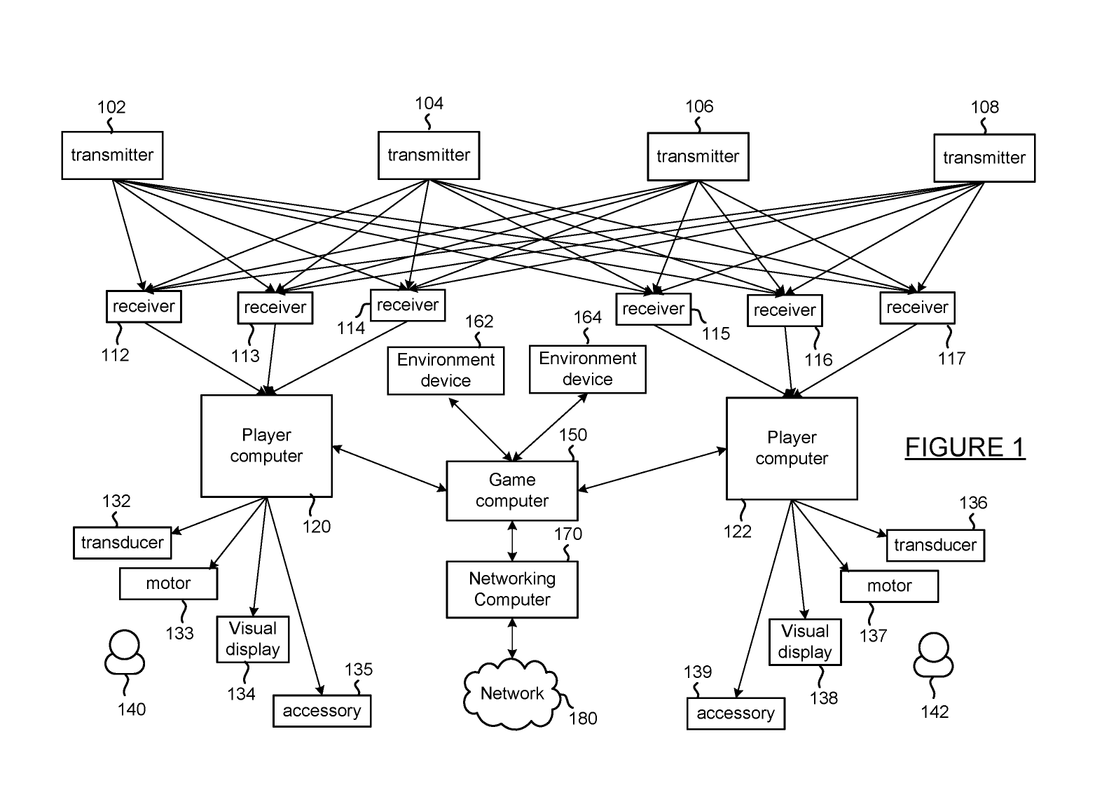

FIG. 1 is a block diagram of a virtual reality system with a wideband-based position tracking system. The system of FIG. 1 includes transmitters 102, 104, 106, and 108, receivers 112, 113, 114, 115, 116 and 117, player computers 120 and 122, transducers 132 and 136, motors 133 and 137, virtual display 134 and 138, accessories 135 and 139, players 140 and 142, game computer 150, environment devices 162 and 164, networking computer 170, and network 180.

Receivers 112-117 can be placed on a player 140 or an accessory 135. Each receiver may receive one or more signals from one or more of transmitters 102-108. The signals received from each transmitter may include an identifier to identify the particular transmitter. In some instances, each transmitter may transmit an omnidirectional signal periodically at the same point in time. Each receiver may receive signals from multiple transmitters, and each receiver may then provide signal identification information and timestamp information for each received signal to player computer 120. By determining when each transmitter signal is received from a receiver, player computer 120 may identify the location of each receiver.

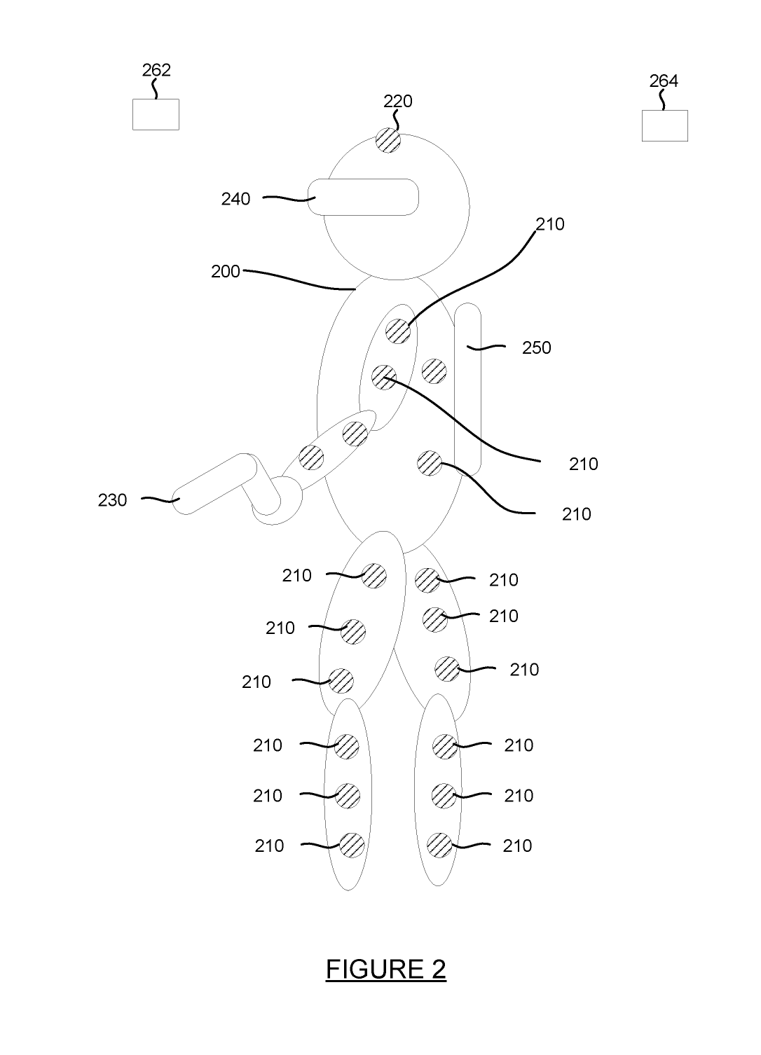

Player computer 120 may be positioned on a player, such as for example on the back of a vest worn by a player. For example, with respect to FIG. 2, a player computer 250 is positioned on a back of player (i.e., user) 200. A player computer may receive information from a plurality of receivers, determine the location of each receiver, and then locally update a virtual environment accordingly. Updates to the virtual environment may include a player's point of view in the environment, events that occur in the environment, and video and audio output to provide to a player representing the player's point of view in the environment along with the events that occur in the environment.

Player computer 120 may also communicate changes to the virtual environment determined locally at the computer to other player computers, such as player computer 122, through game computer 150. In particular, a player computer for a first player may detect a change in the player's position based on receivers on the player's body. The player computer can determine changes to the virtual environment for that player, and provide those changes to game computer 150. Game computer 150 will provide those updates to any other player computers for other players in the same virtual reality session, such as a player associated player computer 122. In some instances, player computer 120 may communicate changes directly to other player computers, such as play computer 122, through a wireless or wired connection between the player computers.

A player 140 may have multiple receivers on his or her body. The receivers receive information from the transmitters and provide that information to the player computer. In some instances, each receiver may provide the data to the player computer wirelessly, such as for example through a radiofrequency signal such as a Bluetooth signal. In some instances, each receive may be paired or otherwise configured to only communicate data with a particular players computer. In some instances, a particular player computer may be configured to only receive data from a particular set of receivers. Based on physical environment events such as a player walking, local virtual events that are provided by the players computer, or remote virtual events triggered by an element of the virtual environment located remotely from the player, haptic feedback may be triggered and sensed by a player. The haptic feedback may be provided in the terms of transducer 132 and motor 133. For example, if an animal or object touches a player at a particular location on the player's body within the virtual environment, a transducer located at that position may be activated to provide a haptic sensation of being touched by that object.

Visual display 134 may be provided through a headset worn by player 140. The virtual display 134 may include a helmet, virtual display, and other elements and components needed to provide a visual and audio output to player 140. In some instances, player computer 120 may generate and provide virtual environment graphics to a player through the virtual display 140.

Accessory 135 may be an element separate from the player, in communication with player computer 120, and displayed within the virtual environment through visual display 134. For example, an accessory may include a gun, a torch, a light saber, a wand, or any object that can be graphically displayed within the virtual environment and physically engaged or interacted with by player 140. Accessories 135 may be held by a player 140, touched by a player 140, or otherwise engaged in a physical environment and represented within the virtual environment by player computer 120 through visual display 134.

Game computer 150 may communicate with player computers 120 and 122 to receive updated virtual information from the player computers and provide that information to other player computers currently active in the virtual reality session. Game computer 150 may store and execute a virtual reality engine, such as Unity game engine, Leap Motion, Unreal game engine, or another virtual reality engine. Game computer 150 may also provide virtual environment data to networking computer 170 and ultimately to other remote locations through network 180.

Environment devices 162 may include physical devices that form part of the physical environment. The devices 162 may provide an output that may be sensed or detected by a player 140. For example, an environment device 162 may be a source of heat, cold, wind, sound, smell, vibration, or some other sense that may be detected by a player 140.

Transmitters 102-108 may transmit a synchronized wideband signal within a pod to one or more receivers 112-117. Logic on the receiver and on a player computing device, such as player computing device 120 or 122, may enable the location of each receiver to be determined in a universal space within the pod.

FIG. 2 is an illustration of multiple receivers configured on a user's body. User 200 may be associated with receivers 210 on the user's legs, arms, front, back, head, and other body positions. Each of the receivers may receive and process multiple wideband signals from a plurality of transmitters within a pod. Receivers may receive the signals as interleaving portions or serially received pulses and process the received portions and pulses. Receivers may determine a time-of-flight for each signal and provide that information to a computing device 250, positioned locally on the proximity of the user. User 200 may have multiple receivers, each with one or more antennas and its own logic to identify a time-of-flight of a pulse and corresponding location of the particular receiver based on wideband signals received by the particular receiver. Accessory 230 may also include one or more receivers, each of which may determine time-of-flight data and position location data associated with the accessory and provided to computing device 250.

Once the receiver position is known, the receiver location is provided to computing device 250 to update a virtual reality environment based on a user's determined position at the particular receiver. A virtual reality engine may be hosted on computing device 250, and may provide a graphic update to the user through head unit 236, which is in communication with computing device 250. In addition to determining the position of one or more receivers associated with parts of the user's body, positions of an accessory 230 may also be determined by one or more receivers positioned on the accessory.

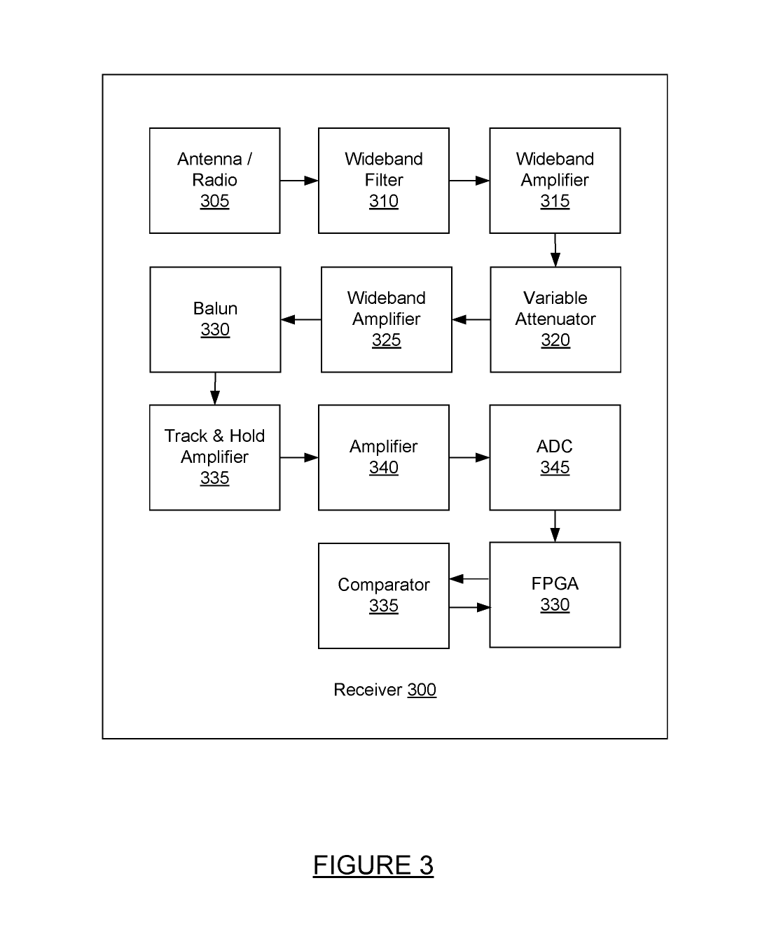

FIG. 3 is a block diagram of a receiver. Receiver 300 provides more detail for one of the plurality of receivers 210 of FIG. 2 and receivers 112-117 of FIG. 1. Receiver 300 includes at least one antenna 305, wideband filter 310, wideband amplifier 315, attenuator 320, another amplifier 325, a balun 330, a track can hold amplifier 335, amplifier 340, analog-to-digital converter 345, field programmable gate array 350, and comparator 355. In some implementations, one or more of the receiver portions 305-355, or similar portions that perform the same functionality, may be implemented as one or more of individual components, circuitry, and logic. In some implementations, the receiver portions 305-355, or similar portions that perform the same functionality, may be implemented in whole or in part on one or more integrated circuits.

Receiver 300 may receive wideband signals from multiple transmitters. Each received wideband signal may be processed by one or more of the modules illustrated in receiver 300. Initially, a wideband signal is received by antenna 305. The received signal may be amplified and may then be filtered by a wideband 6 GHz filter at step 310. The filtered signal is then amplified by wideband amplifier 315 and processed by variable attenuator 320. In some instances, the attenuator may modify the signal in case the received signal cannot be processed by ADC 345, for example if the signal is too big for the sampler of ADC 345. In some instances, variable attenuator 320 may be tuned to attenuate the received signal based on the magnitude of a portion of an identifier contained in the signal. Hence, the attenuator may be used to scale the received signal based on an initial magnitude of the signal observed during a preamble portion of the identifier.

The attenuated signal may then be amplified at step 325 and then processed by a balun 330. Balun 330 may split a received signal into a positive portion and a negative portion. The split signal may then be provided to track can hold amplifier 335. The track can hold amplifier may freeze or hold a slice of the signal to be processed by the analog-to-digital converter. The held portion of the signal is provided to amplifier 340 where it is amplified and provided to ADC 345. ADC 345 samples the held portion of the signal and provides the sampled portion to digital logic, for example FPGA 350.

FPGA receives a pulse from an ADC 345 and processes the pulse. The processing may include applying a low pass filter to remove high-frequency noise, normalizing the filtered pulse, and performing peak detection. In some implementations, performing peak detection may include detecting the strongest pulse at an output of a match filter.

Once a peak is determined, a correlation is performed at the digital logic (e.g., FPGA) to determine the time of the received pulse from a particular transmitter. Correlation may include applying a template across a time window to identify the particular time associated with the pulse, locating the pulses, and associating a time of flight with the pulse and sending the time of flight data with transmitter identifier data to a computing device.

Receiver 300 of FIG. 3 is just one example of a receiver implementation. Other implementations are possible. For example, the receiver may be implemented as a series of integrated circuits and other circuitry, as a single integrated IC, or in some other form.

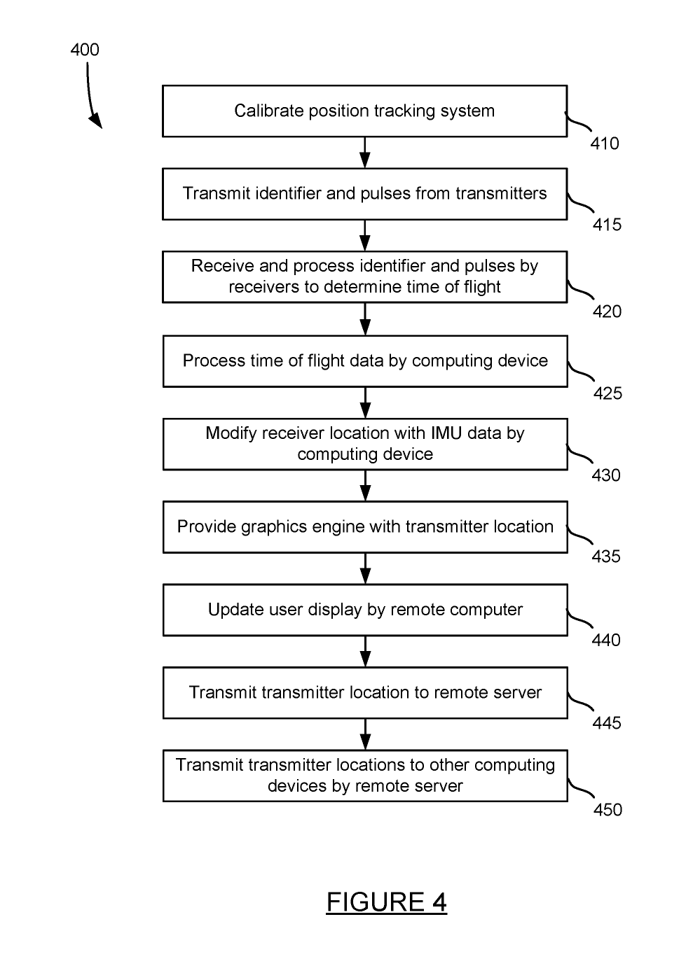

FIG. 4 is a method for performing position tracking in a virtual reality system. First, a position tracking system may be calibrated at step 410. The calibration may involve setting the relative positions of the transmitters with respect to each other within a universal space defined within the pod. Calibrating a position tracking system is discussed in more detail below with respect to the method of FIG. 7.

Identifiers and pulses are transmitted from position tracking transmitters at step 415. In some instances, the identifiers and pulses may be sent serially in turn by multiple transmitters, and in portions rather than as entire and complete sets of information. The pulses and identifiers are sent as wideband signals from transmitters driven by a synchronized clock source. More detail for transmitting identifiers impulses from position tracking transmitters is discussed with respect to the method of FIG. 8.

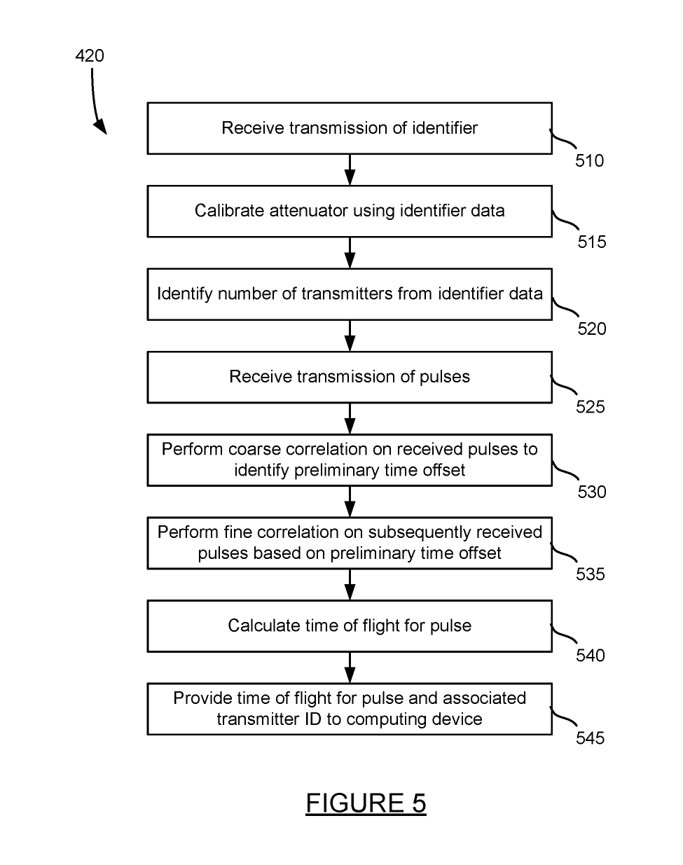

The identifiers and pulses are received and processed by receivers of the position tracking system at step 420. The processing may include determining a time-of-flight of each pulse as well as the identification of the transmitter that sent each pulse. Receiving and processing identifiers and pulses from receivers in a position tracking system is discussed in more detail below with respect to the method of FIG. 5.

Time-of-flight data is provided to a computing device at step 425. In some instances, each receiver may receive wideband signals from multiple transmitters, determine time-of-flight data for each pulse received by a particular transmitter, and provide the time of flight data to the computing device. A computing device may process the time-of-flight data to identify the position of the receiver.

In some instances, the time-of-flight for each transmitter may be used to create a sphere around the transmitter. When four spheres are generated in a model space using time of flight data based on received transmitter signals, a location of the intersection of all four spheres may correspond to a position of the receiver that received the four pulses with the corresponding time of flight data used to create those spheres. A computing device may process time-of-flight data by creating spheres having a radius of the time-of-flight for each transmitter to determine the location of a particular receiver that provided the time-of-flight data to the computing device.

A computing device may compare an updated location of the receiver to determine if a change in position is greater than a threshold value at step 430. If the receiver location appears to change greater than a threshold amount, a computing device may access data from an inertial movement unit to confirm the change in position or to modify the change in position. The inertial movement unit (IMU) may include an accelerometer or other circuits or hardware to detect movement. When the IMU was placed on a user, such as for example the user's head, or elsewhere on the body of the user, a change detected by the IMU may be used to confirm the change in position detected based on time-of-flight data or dampen the change based on detecting movement by the IMU unit.

A graphics engine may be provided with the transmitter location at step 435. Once a computing device has determined the receiver location and modified the receiver location as necessary, the location may be provided to a virtual reality engine for updating the user's virtual position within the virtual environment. Once the user's virtual position has been updated, the remote computer may update the user display at step 440. A user display will be updated to show a new perspective within the virtual environment based on the user's movement. The transmitter location may be sent to a remote server at step 445. With reference to FIG. 1, player computing device 122 may send receiver location to game computer 150, which in turn transmits receiver location to other computing devices such as player computer 120 at step 450.

FIG. 5 is a method for receiving and processing and identifier and pulse by a receiver. The method of FIG. 5 provides more detail for step 420 the method of FIG. 4. First, a transmission of an identifier is received by a receiver at step 510. The transmission of the identifier may include an identifier preamble, sync word, and a transmitter ID. The preamble may include a single byte or signal with an “on” state. A sync word can include a number of bytes or bits in some order that indicate that a transmitter ID is about to be set. The transmitter ID might be a value within a range of bytes that indicate a particular identifier for the transmitter which sent the signal.

In some implementations, a receiver may be connected to a plurality of orthogonally oriented antennas and digital logic. In some implementations, the plurality of orthogonally oriented antennas may include three antennas that are orthogonal to each other. The digital logic may include circuitry and other logic, such as a programmable array logic component, that determines which of the antennas is receiving the strongest transmitted pulse signal. The logic may analyze the magnitude of each signal to determine the strongest transmitted signal. Once the antenna which is receiving the strongest signal is identified, the signal received from the identified antenna is processed.

Next, an attenuator may be calibrated using identifier data at step 515. During the preamble, the attenuator may be scaled based on the signal size of the preamble on signal. The size may be scaled to fit the range of the analog-to-digital converter (ADC) such that the signal can be sampled with the greatest level of accuracy by the ADC. The number of transmitters may then be identified from the identifier data at step 520. In some instances, the receiver knows that the first part of an identifier received from the transmitters, in serial format, is the preamble portion. The receiver also knows how long each “on” preamble signal will last. Since the transmitters are sending “on” signals serially, in turn, the receiver may count the number of preamble “on” signals received to determine the number of transmitters transmitting to the particular receiver.

Pulse transmissions are received by the receiver at step 525. As the pulses are received, logic at the receiver or in communication with the receiver may identify the location of the pulse and a corresponding time of flight for the pulse. An exemplary way to determine the pulse time of flight is by correlating the received pulses. A correlation pulse may be performed one or more times to ensure accuracy and achieve a higher resolution. A coarse correlation and fine correlation are discussed below, but other types of correlation and time of flight determination may be used as well.

A coarse level of correlation is performed on the received pulses to identify preliminary time offset at step 530. The correlation process may be performed by logic on the receiver or in communication with the receiver, such as for example by a field programmable gate array integrated circuit. Performing the correlation may include amplifying the received pulse, filtering the pulse using a low-pass filter, and finding a strongest pulse. Finding the strongest pulse may include finding the peak of an output match filter.

In some implementations, the pulse is applied at ten pico-second (ps) increments of one nanosecond before and one nanosecond after the location at which the peak was detected. In some implementations, a match filter can be used to search a sample space in linear time to produce the same offset.

Once the strongest pulse is identified, a pulse template is accessed and applied against a window known to contain the received pulse. At each increment in which the template is moved across the window, the sum of the differences between the distance of each point in the template and the detected peak are calculated. The position for the template at which the sum of the differences is calculated to be the least is determined to be the preliminary time offset at which the pulse exists in the window.

After identifying the preliminary time offset, a fine correlation is performed on the subsequently received pulses based on the preliminary time offset at step 535. The fine correlation is performed similarly to the coarse correlation using a pulse template and sliding window, except the template is applied to a window that extends from a number of picoseconds before and after the preliminary time offset was detected at step 530 and in one picosecond increments. In some implementations, the template may be applied 6, 9, 10 or some other number of picoseconds before and/or after the preliminary time offset is detected. This provides a picosecond level of granularity for the pulse. Once the fine correlation offset is determined at step 535, the time-of-flight for the pulse may be determined at step 540. The time-of-flight calculated at step 540 is then provided to a computing device along with the associated transmitter ID at step 545. Time-of-flight data is sent, along with the appropriate transmitter ID, for several transmitters from the particular receiver. This allows the computing device determine the position of the particular receiver based on multiple time-of-flight data points.

Some optimizations may be implemented when performing correlation. In some implementations, if a time-of-flight for a particular transmitter has already been determined, and is accessible from memory, the sampling for that pulse may begin at the stored time offset. This allows for sampling at a 200 picosecond window rather than a 400 picosecond window, and only requires capturing 20 samples rather than 400 samples.

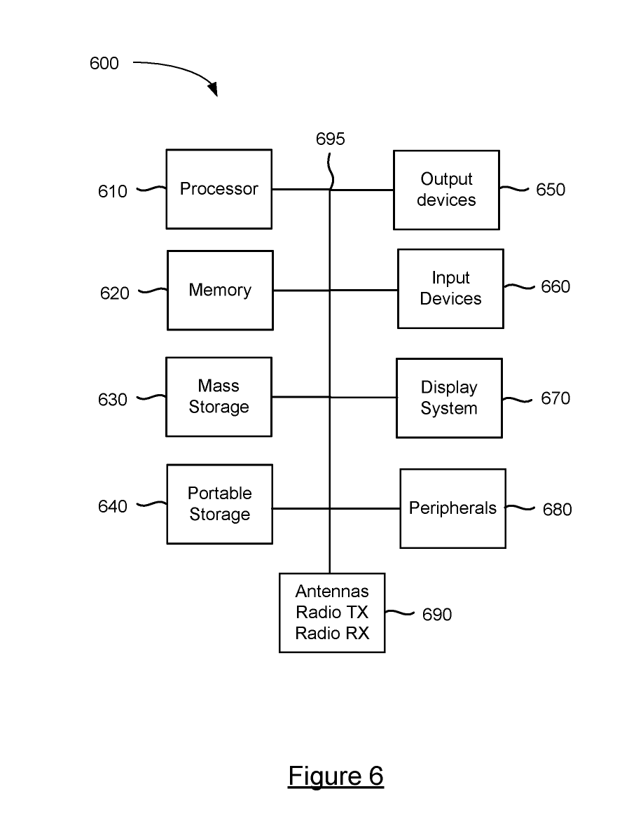

FIG. 6 illustrates an exemplary computing system 600 that may be used to implement a computing device for use with the present technology. System 600 of FIG. 6 may be implemented in the contexts of the likes of player computing devices 120 and 122 and game computer 150. The computing system 600 of FIG. 6 includes one or more processors 610 and memory 610. Main memory 610 stores, in part, instructions and data for execution by processor 610. Main memory 610 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 610 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive, optical disk drive, or solid-state non-volatile memory such as a flash drive, is a non-volatile storage device for storing data and instructions for use by processor unit 610. Mass storage device 630 can store the system software for implementing embodiments of the present invention for purposes of loading that software into main memory 610.

Portable storage device 640 operates in conjunction with a portable non-volatile storage medium, such as a floppy disk, compact disk, Digital video disc, USB flash drive, or SD card, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alphanumeric keypad, such as a keyboard, for inputting alphanumeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for determining a time of flight for a signal within a position tracking system, the method comprising:
receiving, from a plurality of transmitters, synchronized wide-band signals by a first receiver of a plurality of receivers, the plurality of transmitters and plurality of receivers located within a pod,
subsampling the received synchronized wide-band signals received by the first receiver;
performing a first correlation on the sub-sampled received synchronized signals;
determining the time of flight of each wide band signal received by the first receiver based on the correlation; and
providing to a computer the time of flight and a corresponding transmitter identifier for each wide band signal.

2. The method of claim 1, wherein the wide band signal has a frequency within the range of about 3 to 10 gigahertz

3. The method of claim 1, wherein each of the wide-band signals includes a transmitter identifier and pulse data.

4. The method of claim 1, wherein the transmitter identifier includes a preamble, sync word and transmitter data

5. The method of claim 1, wherein the subsampling includes:
performing a first subsampling at a first frequency for a first range of time;
identifying a peak based on the first subsampling;
performing a second subsampling at a second frequency for a second range of time, the second frequency higher than the first frequency and the first range of time shorter than the second range of time; and
refining the peak identification based on the second subsampling.

6. The method of claim 5, wherein the second range of time is centered around the peak identified based on the first sub-sampling.

7. The method of claim 1, wherein the first correlation includes applying a template across a time window to identify the pulse.

8. The method of claim 1, further comprising applying a second template across a second time window to refine the identification of the pulse, the second time window smaller than the first time window and centered on the identified pulse.

9. The method of claim 1, further comprising calibrating the plurality of transmitters with the plurality of receivers.

10. The method of claim 1, wherein the receivers and the transmitters are part of a virtual reality motion tracking system.

11. A method for performing wideband position tracking, the method comprising:
transmitting wide band identifier information and pulses from a plurality of transmitters;
receive and processing the wideband identifiers and pulses by a first receiver of a plurality of receivers;
determining time of flight data by receiver circuitry for each pulse received by the first receiver;
determining the location of the receiver based on the time of flight of at least three pulses received by the receiver;
providing a locally executing graphics engine with the transmitter location; and
updating a graphical user display with updated information based on the graphics engine.

12. The method of claim 11, further including calibrating the position tracking system

13. The method of claim 11, further comprising modifying the receiver location based on inertial measurement unit data associated with the receiver.

14. The method of claim 13, further comprising:
determining a receiver location change exceeds threshold from a previous location;
determining whether inertial measurement unit data confirms the location change is greater than threshold
adjusting the receiver location based on inertial measurement unit data.

15. The method of claim 11, further comprising:
transmitting the transmitter location to remote server by a local machine, the server transmitting the transmitter locations to other remote computers.

16. The method of claim 11, wherein the receivers and the transmitters are part of a virtual reality motion tracking system.

17. A non-transitory computer readable storage medium having embodied thereon a program, the program being executable by a processor to perform a method for determining a time of flight for a signal within a position tracking system, the method comprising:
receiving, from a plurality of transmitters, synchronized wide-band signals by a first receiver of a plurality of receivers, the plurality of transmitters and plurality of receivers located within a pod,
subsampling the received synchronized wide-band signals received by the first receiver;
performing a first correlation on the sub-sampled received synchronized signals;
determining the time of flight of each wide band signal received by the first receiver based on the correlation; and
providing to a computer the time of flight and a corresponding transmitter identifier for each wide band signal.

18. The non-transitory computer readable storage medium of claim 17, wherein the wide band signal has a frequency within the range of about 3 to 10 gigahertz

19. The non-transitory computer readable storage medium of claim 17, wherein each of the wide-band signals includes a transmitter identifier and pulse data.

20. The non-transitory computer readable storage medium of claim 17, wherein the transmitter identifier includes a preamble, sync word and transmitter data

21. The non-transitory computer readable storage medium of claim 17, wherein the subsampling includes:
performing a first subsampling at a first frequency for a first range of time;
identifying a peak based on the first subsampling;
performing a second subsampling at a second frequency for a second range of time, the second frequency higher than the first frequency and the first range of time shorter than the second range of time; and
refining the peak identification based on the second subsampling.

22. The non-transitory computer readable storage medium of claim 21, wherein the second range of time is centered around the peak identified based on the first sub-sampling.

23. The non-transitory computer readable storage medium of claim 17, wherein the first correlation includes applying a template across a time window to identify the pulse.

24. The non-transitory computer readable storage medium of claim 17, the method further comprising applying a second template across a second time window to refine the identification of the pulse, the second time window smaller than the first time window and centered on the identified pulse.

25. The non-transitory computer readable storage medium of claim 17, the method further comprising calibrating the plurality of transmitters with the plurality of receivers.

26. The non-transitory computer readable storage medium of claim 17, wherein the receivers and the transmitters are part of a virtual reality motion tracking system.

27. A non-transitory computer readable storage medium having embodied thereon a program, the program being executable by a processor to perform a method for performing wideband position tracking, the method comprising:\
transmitting wide band identifier information and pulses from a plurality of transmitters;
receive and processing the wideband identifiers and pulses by a first receiver of a plurality of receivers;
determining time of flight data by receiver circuitry for each pulse received by the first receiver;
determining the location of the receiver based on the time of flight of at least three pulses received by the receiver;
providing a locally executing graphics engine with the transmitter location; and
updating a graphical user display with updated information based on the graphics engine.

28. The non-transitory computer readable storage medium of claim 27, the method further including calibrating the position tracking system

29. The non-transitory computer readable storage medium of claim 27, the method further comprising modifying the receiver location based on inertial measurement unit data associated with the receiver.

30. The non-transitory computer readable storage medium of claim 27, the method further comprising:
determining a receiver location change exceeds threshold from a previous location;
determining whether inertial measurement unit data confirms the location change is greater than threshold; and
adjusting the receiver location based on inertial measurement unit data.

31. The non-transitory computer readable storage medium of claim 27, the method further comprising:
transmitting the transmitter location to remote server by a local machine, the server transmitting the transmitter locations to other remote computers.

32. The non-transitory computer readable storage medium of claim 27, wherein the receivers and the transmitters are part of a virtual reality motion tracking system.

33. A system for determining a time of flight for a signal within a position tracking system, the system comprising:
an antenna for receiving a plurality of synchronized wide band signals from a plurality of transmitters within a pod, the
circuitry that subsamples the received synchronized wide-band signals received by a first receiver of the plurality of receivers;
circuitry that calculates a first correlation on the sub-sampled received synchronized signals;
circuitry that determines the time of flight of each wide band signal received by the first receiver based on the correlation; and
circuitry that provides to a computer the time of flight and a corresponding transmitter identifier for each wide band signal.

34. The system of claim 33, wherein the circuitry is implemented on an integrated circuit.

35. The system of claim 33, wherein the wide band signal has a frequency within the range of about 3 to 10 gigahertz

36. The system of claim 33, wherein each of the wide-band signals includes a transmitter identifier and pulse data.

37. The system of claim 33, wherein the transmitter identifier includes a preamble, sync word and transmitter data

38. The system of claim 33, wherein the circuitry performs a first subsampling at a first frequency for a first range of time, identifies a peak based on the first subsampling, performs a second subsampling at a second frequency for a second range of time, the second frequency higher than the first frequency and the first range of time shorter than the second range of time, and refines the peak identification based on the second subsampling.

39. The system of claim 38, wherein the second range of time is centered around the peak identified based on the first sub-sampling.

40. The system of claim 33, wherein the first correlation includes applying a template across a time window to identify the pulse.

41. The system of claim 33, the circuitry applying a second template across a second time window to refine the identification of the pulse, the second time window smaller than the first time window and centered on the identified pulse.

42. The system of claim 33, the circuitry calibrating the plurality of transmitters with the plurality of receivers.

43. The system of claim 33, wherein the receivers and the transmitters are part of a virtual reality motion tracking system.
